(19) United States
(12) Patent Application Publication
(10) Pub. No.: US 2016/0342720 A1
(43) Pub. Date: Nov. 24, 2016

(54) METHOD, SYSTEM, AND COMPUTER PROGRAM FOR IDENTIFYING DESIGN REVISIONS IN HARDWARE DESIGN DEBUGGING

(71) Applicants: Andreas Veneris, Toronto (CA); Zisis Paraskevas Poulos, Toronto (CA); Djordje Maksimovic, Toronto (CA); John Adler, Toronto (CA)

(72) Inventors: Andreas Veneris, Toronto (CA); Zisis Paraskevas Poulos, Toronto (CA); Djordje Maksimovic, Toronto (CA); John Adler, Toronto (CA)

(21) Appl. No.: 15/158,801

(22) Filed: May 19, 2016

Related U.S. Application Data
(60) Provisional application No. 62/165,544, filed on May 22, 2015.

(51) Int. Cl. G06F 17/50

(52) U.S. Cl. CPC G06F 17/5045; G06F 17/5009; G06F 2217/16

(57) ABSTRACT

The present invention provides a method, system and computer program for ranking suspect components in a hardware design that fails verification, based on their likelihood of being actual error sources, and identifying design revisions or branches that are likely to contain actual error sources. The method is implemented as a suspect and revision ranking engine. The ranking engine involves the input of an engineer to provide an initial set of suspects or it can use the application of at least one automated debugging tool for each failure exposed by verification, and collects suspect sets returned by these tools. These tools can be based on simulation, path tracing, ATPG, BDDs, SAT, and QBF techniques. The engine applies either an analytical or statistical process on the suspects that are collected, to identify suspect components that are likely responsible for a large number of design failures. The process to rank suspect components can use various analytical or statistical techniques, such as cluster analysis, branch-and-bound, classification, and counting methods. The engine also involves the use of a parser to collect information from design revisions or branches and revision metadata. The information that is collected from the parser program is used by either a statistical or analytical system to classify which revisions or branches are likely to contain actual error sources. The above system can be implemented by using techniques, such as Support Vector Machines, logistic regression, the perceptron algorithm, and dictionary-based search. The engine finally involves a method to match ranked revisions or branches to ranked suspects. This process further refines the ranks of revisions or branches and outputs ranked lists of suspects and ranked lists of revisions or branches for further analysis by the engineer(s).

### FIELD OF THE INVENTION

The present invention relates to the field of hardware design debugging. The present invention more particularly relates to identifying hardware design revisions that are responsible for hardware failures exposed when the hardware design is subjected to verification.

### BACKGROUND OF THE INVENTION

A typical hardware design cycle starts with a specification document describing the intended functionality of the design. The specification is used to create the hardware design, which is typically implemented using a Hardware Description Language (HDL). HDL designs are most commonly implemented at the Register Transfer Level (RTL) using Verilog and VHDL languages, which are HDLs used in electronic design automation to design digital and mixed-signal systems, such as field programmable gate arrays and integrated circuits. The specification is also used to determine the expected behavior specified by the verification environment.

Along these lines, verification is the process of determining whether errors exist in a hardware design. Verification can be performed by using testbenches that apply stimulus to the design via diagnose input vectors, and simulation tools or formal verification tools. Verification forms a major bottleneck in modern hardware design cycles, consuming up to 70% of the design effort. Of the time spent in verification, a major part is dedicated to the task of hardware design debugging which is reported to take half of this time.

Hardware design debugging is the process of locating errors in designs after verification methodologies and techniques determine the presence of such errors. Today, debugging is majorly a manual task where the verification engineer typically uses the erroneous response of the design, the expected behavior as stated by specification and the diagnose vectors, to determine what design components, usually HDL statements and/or signals, are responsible for the erroneous behavior. These components whose values appear to be inconsistent with those of the specification are referred to as suspect components or simply suspects.

Tools that automate debugging have been introduced in recent years, such as OnPoint by Vennsa Technologies, Inc. [1], and Verdi by Synopsis, Inc. [2]. Many of these tools use simulation-based techniques, such as path tracing, or Automatic Test Pattern Generation (ATPG) methods [3]. Other tools employ formal engines such as Binary Decision Diagrams (BDDs), Satisfiability (SAT) and Quantified Boolean Formulas (QBF) [4, 5]. The above tools automatically determine and return suspect components in the design. Among the suspects that are identified by these tools, some may be equivalent, in that they produce the same erroneous behavior under all diagnose input vectors. There may also exist suspects returned that are false positives, that is, they can correct the particular diagnose input vector but they cannot correct other diagnose vectors. In that sense, false positives do not actually correspond to an error present in the design. In most automated debugging tools the actual design error will be included among the suspects retuned by these tools. Formal tools guarantee to find the actual error and equivalent ones due to their exhaustive search.

The present invention described here can work alongside the aforementioned tools, but it can also operate without them as a stand-alone method.

Verification can be performed either on-line or off-line. In on-line verification the engineer analyzes the design through model checking or simulation to discover an error trace (sequence of stimuli) that exposes a particular single failure. Then, debugging commences trying to localize the error source of that particular failure. The error source can reside within a design component, design module, or it can be a design signal. Once the error source is localized, the engineer(s) need(s) to identify the error source and perform a change (correction) that will remove the failure exposed by verification.

On the other hand, off-line verification, often referred to as regression verification, is usually performed when the design undergone multiple revisions (modifications) before the last verification stage. These design revisions along with relevant metadata (author of revision, time of revision, author's comments, purpose of revision, etc.) reside in a version control system, such as Apache Subversion (SVN), CVS, and Git. A version (or revision) control system is a computer program that tracks and manages changes to files, documents, and other textual information that comprise the source code of the design under verification. Regression applies a large number of diagnose vectors (or tests) to exercise a majority of the design functionality, since multiple revisions may have affected many design elements. Performing regression verification today is mostly an automated process. However, it is a time-consuming process often performed overnight or over the span of multiple days, and it usually results in multiple diagnose vectors failing, where each failing diagnose vector indicates some functional failure. When the verification engineer(s) examine(s) these failing diagnose vectors, hardware debugging is usually performed in a coarse-grain manner by parsing simulation logs, analyzing simulation waveforms and many error messages. Candidate revisions that may have introduced design errors are discovered and distributed to the appropriate verification or design engineer(s) for the subsequent debugging. Due to the excessive amount of information that needs to be analyzed after regression, and because multiple engineers may be working on the same design, the process of identifying candidate revisions and distributing them to the proper engineer(s) needs to be accurate. If it is not, this results in significant costs and delays, and in multiple debugging iterations. While regression is mostly automated, identifying candidate revisions that may contain design errors is a predominantly manual and resource-intensive process, often performed by one or more verification and/or design engineers.

The present invention can operate in both of these on-line and off-line verification modes.

Whether verification is performed on-line or off-line, the verification engineer attempts to correct the error(s), while being guided by suspects that are returned by debugging. When all engineers are done with corrections, verification is rerun to ensure that no diagnose vectors fail. It becomes apparent that it is of great importance for the engineer(s) to perform debugging exactly on those revisions that contain errors whose correction will make all previously failing vectors to successfully pass in the following verification run. Therefore, it is important to determine which suspects in the returned set are a false positive or an equivalent suspect, and rank all suspects based on which ones are most likely to be the actual design error(s). This not only reduces the number of suspects that need to be examined by the engineer(s), but also offers better estimates as to what revisions contain actual design errors or not. It is to be noted that identifying and correcting actual design errors is almost always preferable to correcting equivalent suspects in an industrial context so to preserve most of the existing engineering effort already invested in the design.

Recent work in [6] has improved the process of prioritizing suspects for debugging by implementing machine learning engines that determine which engineers are best suited to rectify a failure. This work tries to cluster (i.e., bin) failing diagnose vectors and sets of suspect components according to their effect on the functionality of the design, but it does not take into consideration information contained within design revisions as it ranks the suspects.

What is not provided by current methods is a means to parse information from a revision control system in order to: (a) rank suspect locations based on the likelihood of being actual error sources or not, (b) identify exactly those revisions that are likely to contain actual design errors and ought to be analyzed with high priority doting debugging.

### BRIEF DESCRIPTION OF THE DRAWINGS

A detailed description of the embodiments is provided herein below by way of example only and with reference to the following drawings, in which:

FIG. 1 illustrates one iteration of a verification flow in accordance with the present invention.

FIG. 2 illustrates a system setup for revision ranking in an example verification flow in accordance with the present invention.

FIG. 3 illustrates an example of hardware design revision history represented as a directed acyclic graph.

FIG. 4 illustrates a system setup for ranking linear revisions in accordance with an embodiment of the present invention.

FIG. 5 illustrates an example of a classification process using keywords in revision metadata to detect revisions that are likely to contain actual error sources.

FIG. 6 illustrates an example of a process to assign weights and ranks to suspect components and design revisions.

FIG. 7 illustrates a system setup for ranking linear and non-linear revisions and/or revision branches in accordance with an embodiment of the present invention.

In the drawings one embodiment of the invention is illustrated by way of example. It is to be expressly understood that the description and drawings are only for the purpose of illustration.

### SUMMARY

The present invention provides a method, system, and computer program for ranking suspect components based on their likelihood of being actual error sources, and identifying revisions that are likely to contain actual error sources. The invention may be included as part of a complete verification solution or as a stand-alone tool.

The method requires an initial set of suspects. These suspects can be provided by the engineer, an automated debugging tool, or both. These tools can be based on, but not limited to, simulation, path tracing, ATPG, BDDs, SAT, and QBF techniques.

The method involves the application of either an analytical or statistical process on the suspects that are collected, to identify suspect components that are likely to be actual error sources. Those that are identified as such are assigned as high rank based on a weight function. The weight function assigns a low rank to those suspects that are less likely to be actual error sources.

The proposed method also involves the use of a program (parser) to parse design revisions and/or revision metadata available in the version control system associated with the design that is undergoing verification and debugging. The method is not limited to any specific type of version control system. The information that is collected from the parser program is used by either a statistical or analytical system to classify (determine) which revisions are most likely to have introduced design errors.

The method further involves an analytical system that matches ranked suspects to classified revisions. This process filters out revisions that are guaranteed not to have introduced actual design errors. It also identifies, based on the matching results, which revisions contain suspects of high rank, and are therefore more likely to have introduced actual design errors, and returns these revisions in the form of a list. Every revision in the list is also ranked based on the ranks of suspects that are present in that revision.

Before explaining at least one embodiment of the invention in detail, it is to he understood that the invention is not limited in its application to the detail of construction and to the arrangement of components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### DETAILED DESCRIPTION OF THE INVENTION

The present invention provides a method, system, and computer program for ranking suspect components in a hardware design that fails verification, based on their likelihood of being actual error sources, and ranking design revisions based on their likelihood of having introduced actual error sources.

Any module or component described herein that reads/executes instructions may involve or have access to computer readable media. These include volatile and non-volatile, removable and non removable computer storage media, and removable and/or non-removable data storage devices, such as, for example, magnetic disks, optical disks, or tape. Computer storage media may be implemented in any method or technology for information storage, such as data structures, computer readable instructions, or other data. Examples of computer storage media include ROM, RAM, EEPROM, flash memory or other memory technology, CD-ROM, DVD or other optical storage, magnetic cassettes, magnetic tape, magnetic disk or other magnetic storage devices, computer instruction signals embodied in a transmission medium that may include a communication network, such as the Internet, or any other medium that can be used to store required information and that is accessible by an application, module, or both. Any application or module described herein may be implemented using instructions that may be stored on such computer readable media.

When verification of a hardware design identities the presence of errors in the design, then debugging commences and aims at determining design components (gates, signals, HDL statements, and/or lines) that should be considered as potential errors. These components are referred to as suspects, and each suspect may or may not be an actual error source. The process can be done manually by assessing simulation waveforms and/or monitoring and analyzing errors logs. It can also be done automatically by means of tools that have been proposed in prior art. Specifically, the methods proposed in [3-5], and the methods disclosed in U.S. Pat. No. 8,881,077 to Veneris et al., and in U.S. Pat. No. 8,751,984 to Veneris et al., automatically identify suspects and return these to engineers to aid in their attempt of correcting the design. The method disclosed in U.S. Pat. No. 9,032,371 to Daniel Hansson et al. reports revisions that may have introduced design error(s) without ranking them. More specifically Hansson iteratively tests (i.e. simulates) each revision to see if it corrects the diagnose vectors; then reports back with no prioritization on the revisions, nor ranks according to what is the actual error, nor is Hanson's iterative testing based on statistical methods as outlined herein.

The suspects or design revisions that are returned by above means are not ranked automatically with respect to the likelihood of being actual error sources or containing actual error sources, respectively. The problem of prioritizing (by means of a ranking engine) suspects and design revisions according to the above likelihood is addressed by this invention.

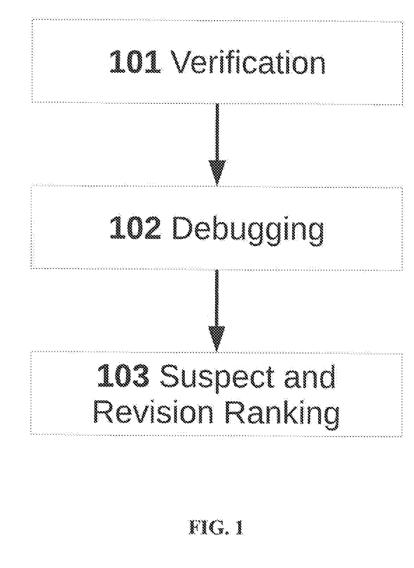

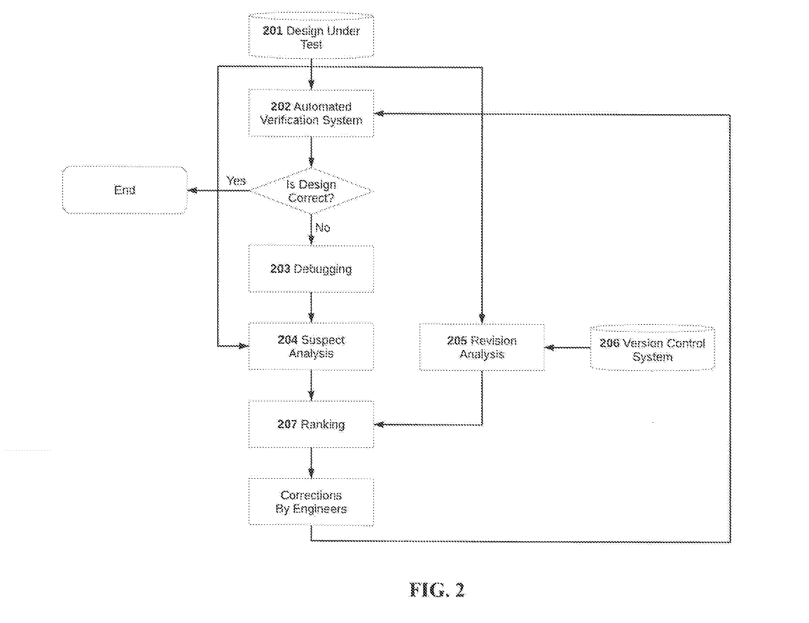

FIG. 1 illustrates one iteration of a verification flow in accordance to the present invention. The suspect and revision ranking engine (103) of the present invention is an additional process that operates immediately after a plurality of suspects is determined by means of automated tools or manually by the engineer during debugging (102) of a hardware design that has undergone verification (101). The system of the present invention may be implemented as a suspect and revision ranking engine that is operable to generate one or more ranked lists of suspects anchor ranked lists of revisions, such that suspects that appear higher in the ranked list are more likely to be actual error sources than suspects appearing lower in the list, and revisions that appear higher in the ranked list are more likely to contain actual error sources than revisions appearing lower in the list. FIG. 2 illustrates an example verification flow with an integrated system setup in accordance with the present invention. As exemplified in FIG. 2, the design under test 201 may be analyzed by an automated verification system 202. If the design is correct according to its specifications then the process terminates. If the design is not correct, then a debugging task (203) takes place. Once debugging is complete, a suspect analysis step 204 may take as inputs the results of the debugging step 203 along with the design under test 201. Furthermore, a revision analysis step (205) may take as inputs the design under test 201 along with information from a version control system (206) that is used to track the development of the design under test. For both tasks 205 and 206, the design under test may be passed as input in various forms, such as, for example, source code, synthesized flat netlist, synthesized hierarchical netlist, abstract syntax tree, etc. The outputs of tasks 205 and 206 may then be combined in a way that is described further in this detailed description, in order to produce a ranking (207) of suspects and/or revisions. The ranking may then be used by one or more engineers in order to perform corrections in the design under test. The process then may be repeated, starting at the verification step 202 until all necessary corrections are performed and the design passes verification.

The ranking engine may include or be linked to means of accepting user input, and providing textual and/or graphical output to the user. The engine may be provided with one or more inputs from an automated debugging tool and/or from a user in the form of suspects. The automated debugging tool may be OnPoint by Vennsa Technologies, Inc. or Verdi by Synopsys, Inc. or any SAT-based, QBF-based, BOD-based, simulation/path-trace based tool [5].

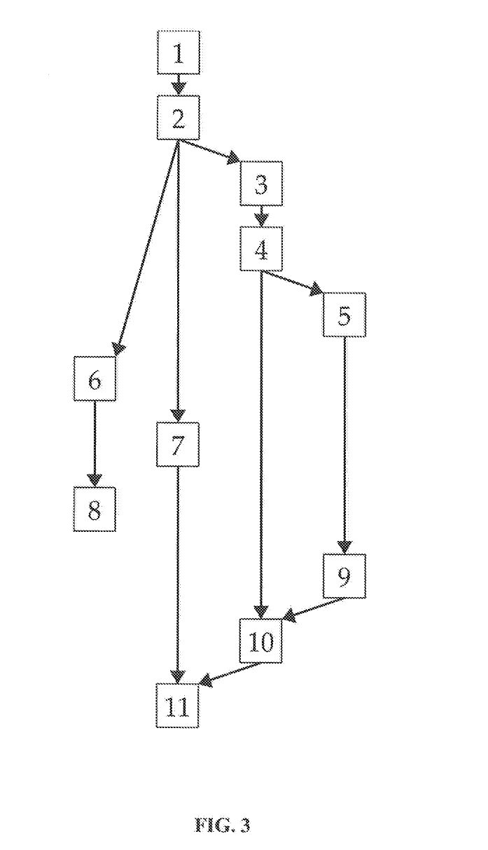

The engine may also be provided with one or more inputs from a version control system and/or from a user in the form of design revisions. The inputs received from a version control system may be linear or non-linear. Linear inputs correspond herein to a plurality of design revisions when branching is not present. While non-linear inputs refer to a plurality of groups of revisions referred to as branches, when branching is present. Branching is a commonly used methodology to duplicate code in order to isolate code development for a particular feature or bug fix and allow it to be performed in parallel by different developers. Whether branching is present or not, the inputs received from the version control system are referred to as the revision history of a design. As illustrated in FIG. 3, the revision history of a design can be represented by means of a Directed Acyclic Graph (DAG). During development, one or more developers may perform tentative changes in the code of the design. A commit operation makes these tentative changes permanent. Every commit corresponds to a different version of the design code. As exampled in FIG. 3, commits 1, 2, 7, and 11 are on the mainline, usually the most up-to-date development version of the design code. Other commits indicate branches. Commits 3 and 6 branch off the mainline, while commit 5 branches off another branch (nested branch). Once development on the design feature or bug fix is complete, the child branch is merged onto the parent branch. The process of merging a child branch onto the parent branch involves the identification of cumulative code changes (i.e. changes in the text files comprising the code of a design) between the start and the end of the branch. These code changes can be identified by means of textual operations, such as, for example, a diff operation. Once the cumulative changes are identified, they are applied to the parent branch. As seen in FIG. 3, the child branch comprised of, commits 5 and 9 is merged onto the parent branch comprised of commits 3, 4, and 10. In turn, the child branch comprised of commits 3, 4, and 10, and the changes of commits 5 and 9, is merged onto the parent branch comprised of commits 2, 7, and 11 which in this figure is the mainline.

The engine may be further provided with one or more inputs by a user in the form of one or more parameters. These parameters may include the user's estimation of how many errors are present in the design and/or the user's estimation on which suspects or revisions are more likely to be actual error sources or contain actual error sources, respectively. The engine can, however, operate without any of said estimation parameters provided by the user.

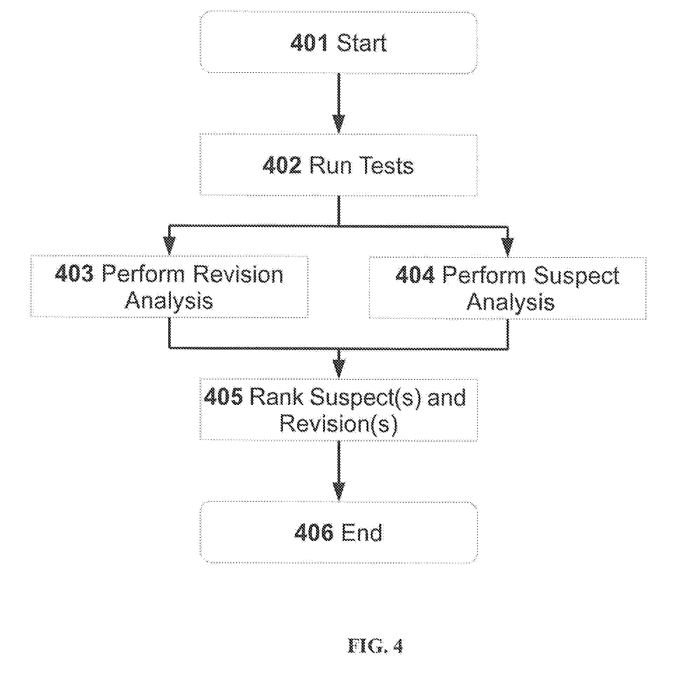

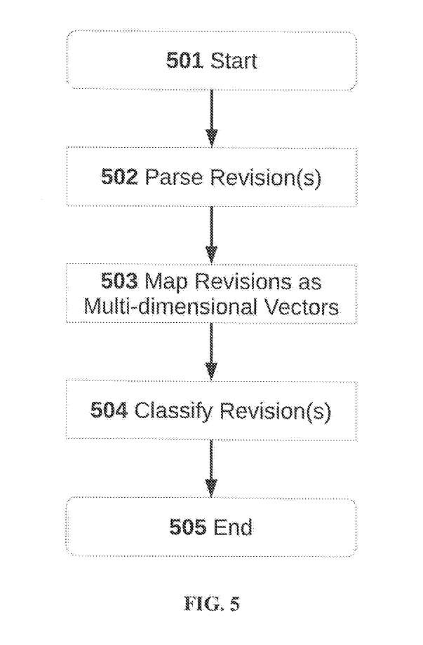

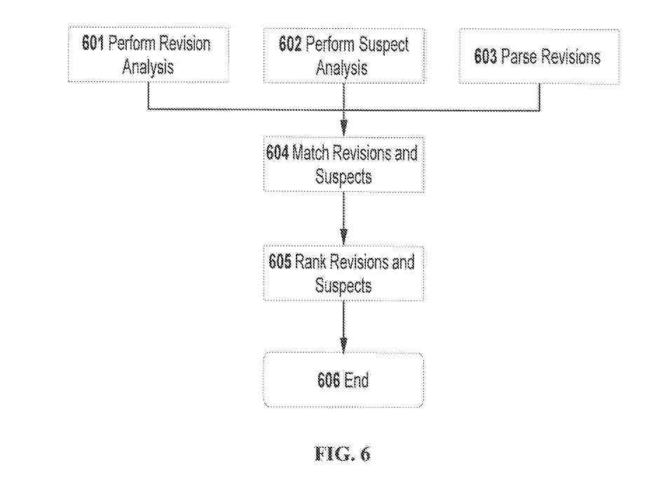

In one embodiment of the present invention inputs are given in the form described above, with inputs from version control systems restricted to linear inputs. In this embodiment, the ranking engine may perform the following three tasks, which are also illustrated in FIG. 4:
1. A suspect analysis task (404) involving the application of weights to suspects, such that suspects that are likely to be error sources receive a larger weight and vice versa. The weight can be a real number between minus infinity and plus infinity. The weight of a suspect can be determined by an analytical or statistical method. For example, it can be analytically determined by counting the occurrences of a suspect in the suspect sets that are passed as input to the engine by the debugging tool or the user, where each suspect set corresponds to a particular failure exposed by verification. As another example, the weight of a suspect can be statistically determined by means of a statistical metric that uses features of the suspect, and based on these it quantifies a likelihood of the suspect being an actual error source. These features may include, but are not limited to the location of the suspect in the HDL, or an approximation of its number of occurrences in given suspect sets and its relative location in the with respect to other suspects. In order to compute the above weights various analytical or statistical techniques may be employed, such as cluster analysis, branch-and-bound, classification, counting methods, etc.
2. A revision analysis task (403) involving the application of weights to design revisions, such that revisions that are likely to contain error sources receive a larger weight and vice versa. The weight can be a real number between minus infinity and plus infinity. The weight of a revision can be determined by an analytical or statistical method. An analytical method, for example, may involve the identification of keywords (word reduction) by means of a parser program in a revision or the metadata of a revision (such as commit logs), and based on these keywords decide whether a revision is likely to contain an error source or not. In an analytical method this decision can be rule-based. For example the presence or absence of a keyword may definitely discard a revision from possible consideration and apply an extremely to weight. On the other hand, a statistical method, may involve a means of quantifying the likelihood of a revision containing an actual error source. FIG. 5 illustrates an example of a statistical process to quantify the likelihood of a revision containing an actual error source. This quantification may be based on parsing (502) textual data (characters/words/phrases/sentences) within a given revision, where each textual datum is used to generate a multi-dimensional mapping (503) of the revision, where the revision is represented by a multi-dimensional vector, and where a statistical model (classification/prediction model) uses this multi-dimensional representation to determine the weight assigned to that revision. Methods that can generate a multi-dimensional vector representation using parsed data from a revision may include the following: word embedding methods, bag-of-word methods, Term Frequency-Inverse Document Frequency (TF-IDF) methods, convolution methods, etc. The resulting revision representations may be used by various techniques to quantify the weight of said revisions. Techniques that may be applied toward this goal include classification methods (505), such as Support Vector Machines, logistic regression, the perceptron algorithm, multilayer perceptrons, deep learning using deep neural networks and/or convolutional neural networks etc. [7] or dictionary based search. The engine may parse one or more previous revisions that have been marked as faulty or error-free during previous verification sessions, and use these revisions to train and construct a prediction model for the statistical techniques above.
3. A suspect and/or revision ranking task (405) that uses the weights of suspects and revisions in conjunction to output one or more ranked lists of suspects and/or ranked lists of revisions. FIG. 6 illustrates an example of a process to assign ranks to suspect components and design revisions. To this end, the engine may employ a matching process (604) between ranked revisions and ranked suspects, which comprise the output of revision analysis (601) and suspect analysis (602) tasks, respectively. The matching process may involve the identification of HDL changes in a revision, which can be the output of a parser program 603 such as a diff operation. If changes in a revision correspond to one or more suspects, then the revision matches to those one or more suspects. This process does not affect the rank of a suspect, but may affect the weight of a revision. Specifically, if a revision matches to one or more suspects that have a high rank as computed in step 403, then the revision receives an even larger weight. On the other hand, if a revision matches to one or more suspects that have a low rank as computed in step 403, then the weight of the revision is reduced. The way the weight of revisions is affected may be determined through metrics involving the product of suspect and revision weights, the sum or average of weights between revisions and their matching suspects, etc. Once the matching process is complete and final weights are determined, the engine may sort suspects sets and revisions in order of decreasing weight and output these in the form of ranked lists (605), such as the suspect (revision) of largest weight receives a rank of 1 in the ranked suspect (revision) list, the suspect (revision) of second largest weight receives a rank of 2 in the ranked suspect (revision) list, etc.

It is to be understood that the engine may perform tasks 403 and 404 above either in parallel or sequentially. However, both tasks 403 and 404 always precede task 405.

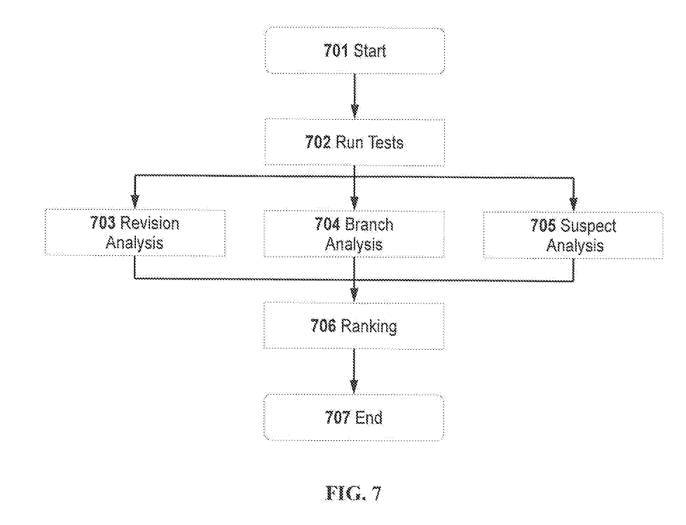

In another embodiment of the present invention inputs are given in the form described previously, where inputs from version control systems can be non-linear. FIG. 7 illustrates a system setup where inputs from the version control system are non-linear, in accordance with an embodiment of the present invention. The difference between this embodiment and the one described in FIG. 4 is a new step, referred to as the branch analysis step (704), and a modified ranking process (706), both of which are shown in FIG. 7. The embodiment of FIG. 7 may perform the following four tasks:
1. A suspect analysis task 705 that is identical to step 404 in the description of the embodiment in FIG. 4.
2. A revision analysis task 703 that is identical to step 403 in the description of the embodiment in FIG. 3.
3. A lunch analysis task (704). The branch analysis step receives as input branches of revisions and achieves two goals: (a) it identifies and eliminates redundant branches (i.e. branches that do not affect the mainline) and/or functionally redundant revisions (i.e. revisions that do not affect the functionality of the set of changes of a branch), and (b) it applies proper weights to branches, such that branches more likely to contain error sources receive as larger weight and vice versa. The reason behind removing redundant revisions is to maintain a set of branches that is functionally relevant to the debugging task. By removing these revisions any analysis that follows takes into account only useful version control data. Redundant branches are identified as all these branches that are not merged, directly or indirectly, onto the mainline. In version control systems with real branching (e.g. Git), this information is available trivially. In version control systems without real branching (e.g. Subversion), the revision history is modeled as a DAG. Graph-based search algorithms are used on the graph model to identify branches that are not merged onto the mainline. Redundant revisions are identified by locating revisions in non-redundant branches that do not contribute to the set of changes of their respective branches. This can be done simply by performing a text-based comparison between the changes of each commit in a branch and the set of changes of the branch. More complex methods can also be used, such as performing static and dynamic code analysis to identify commits that contribute no functional changes to a branch.
4. A suspect and/or revision and/or branch ranking step (706). This step combines the weights of suspects, non-redundant revisions and non-redundant branches to output one or more ranked lists of suspects and/or ranked lists of revisions and/or ranked lists of branches. Toward this goal, the engine may employ a matching process between ranked suspects, ranked revisions and ranked branches. The matching process may involve the identification of HDL changes in non-redundant revisions that belong to non-redundant branches, by means of a parser program. If changes in a non-redundant revision correspond to one or more suspects, then the revision and corresponding branch matches to those one or more suspects. This process does not affect the rank of a suspect, but it may affect the weight of a revision and/or branch the revision belongs to in an identical manner compared to step 405 in the embodiment of FIG. 4. The way the weight of revisions and/or branches is affected may be determined through metrics involving the product of suspect and revision weights, the sum or average of weights between revisions and their matching suspects, the minimum weights across revisions that belong to a particular branch, etc. Once the matching process is complete and final weights are determined, the engine may sort suspects sets, revisions and/or branches in order of decreasing weight and output these in the form of ranked lists, such as the suspect/revision/branch of largest weight receives a rank of 1 in the ranked suspect/revision/branch list, the suspect/revision/branch of second largest weight receives a rank of 2 in the ranked suspect (revision) list, etc.

It is to be understood that the engine may perform tasks 703, 704 and 705 above either in parallel or sequentially. However, tasks 703, 704 and 705 always precede task 706.

### REFERENCES

[1] www.vennsa.com

[2] www.synopsis.com

[3] M. Abramovici, P. R. Menon, D. T. Miller, “Critical path tracing—an alternative to fault simulation”, in Proc. of Design Automation Conference, 1988, pp. 468-474

[4] A. Smith, A. Veneris, M. F. Ali and A. Viglas, “Fault Diagnosis and Logic Debugging Using Boolean Satistiability”, in IEEE Transactions in CAD, vol 24, no 10, pp. 1606-1621, 2005

[5] A. Veneris, S. Safarpour, “The day Sherlock Holmes decided to do EDA”, in Proc. of Design Automation Conference, 2009, pp. 631-634

[6] Z. Poulos and A. Veneris, “Clustering-based failure triage for rtl regression debugging,” in IEEE Int.'l Test Conference, 2014.

[7] C. M. Bishop, Pattern Recognition and Machine Learning (Information Science and Statistics), Springer, 2007.

1. A system for ranking suspect components in a hardware design comprising:
a) ranking engine for:
i) receiving an initial set of suspects, and/or;
ii) collecting suspect sets from at least one automated debugging tool;
to identify and rank suspect components and design revisions that are likely responsible for design failures.

2. A system as claimed in claim 1, wherein said ranking engine:
a) ranks suspect locations based on the likelihood of being actual error sources or not;
b) identifies and ranks those revisions or branches that are likely to contain actual design errors so as to be analyzed with higher priority during debugging.

3. A system as claimed in claim 2 wherein said debugging tool is selected from the group of tools based on simulation, path tracing, ATPG, BDD, SAT and/or QBF techniques.

4. A system as claimed in claim 3 wherein said ranking engine includes a parsing means to collect information from design revisions, branches, and revisions metadata.

5. A system as claimed in claim 4 wherein said ranking engine includes a means to identify redundant revisions and branches.

6. A system as claimed in claim 5 wherein said ranking engine provides analytical and/or statistical means to identify suspect components that are likely to be actual error sources.

7. A method of ranking suspect components in a hardware design comprising that fails verification comprising:
a) providing input into a ranking engine from
i) an initial set of suspects; and/or
ii) collecting suspect sets returned from at least one automated debugging tool for each failure exposed by verification;
b) applying analytical and/or statistical computation on the suspect components that are likely to be actual error sources.

8. A method as claimed in claim 7 including classifying which revisions or branches are likely to contain actual error sources.

9. A method as claimed in claim 8 including matching ranked revisions or branches to ranked suspects

10. A computer implemented program that:
a) permits input into a ranking engine from
i) an initial set of suspects; and/or
ii) collecting suspect sets returned from at least one automated debugging tool for each failure exposed by verification; and
b) provides analytical and/or statistical computation on the suspects that are likely to be actual error sources.
